(19) United States
(12) Patent Application Publication
(10) Pub. No.: US 2014/0278842 A1
(43) Pub. Date: Sep. 18, 2014

(54) TEMPERATURE SENSOR AND SENSING PROCESS

(71) Applicant: NEXLEAF ANALYTICS, Los Angeles, CA (US)

(72) Inventors: Martin L. LUKAC, Los Angeles, CA (US); Eric GRAHAM, Los Angeles, CA (US)

(73) Assignee: NEXLEAF ANALYTICS, Los Angeles, CA (US)

(21) Appl. No.: 13/840,479

(22) Filed: Mar. 15, 2013

(51) Int. Cl. G04F 10/00; G06Q 30/04; G06Q 30/02

(52) U.S. Cl. CPC G04F 10/00; G06Q 30/0207; G06Q 30/04
USPC 705/14.1; 368/9

(57) ABSTRACT

An apparatus for encoding a stove usage time includes a circuit, a temperature switch, an input device, and an output device. The circuit includes a processor and an internal timer. The temperature switch is communicatively linked to the circuit. The input device is electrically connected to the circuit and transmits a status request to the processor in response to receiving a user input. The internal timer increments an accumulated time of the internal timer by a usage time. The usage time is based on a duration the temperature switch detects temperatures higher than the minimum threshold. The processor accesses the incremented accumulated time of the internal timer and stores the accumulated time in a memory. The processor reads the incremented accumulated time from the memory, encodes the incremented accumulated time into an encoded value, and causes the output device to produce the encoded value in response to the status request.

### BACKGROUND

1. Field

The present disclosure relates to temperature sensors and, more specifically, to systems and processes for collecting, encoding, and transmitting cook stove usage statistics using a temperature sensor.

2. Related Art

Traditional cook stoves release carbon dioxide (CO₂) into the air, a major global warming gas. Traditional cook stoves also release Short Lived Climate Pollutants (SLCPs), such as black carbon, methane, and ozone. SLCPs have global warming potentials that are even larger than the potential of CO₂. In addition to the climate impacts, SLCPs also have grave human impacts. The release of SLCPs into the air have caused over 2 million deaths, hundreds of millions of dollars in crop damages, the melting of glaciers in the Himalayas/Tibet region, and disruption of rainfall.

While improved cook stoves that significantly reduce emissions of CO₂ and SLCPs have become available, there is little incentive for owners of traditional cook stoves to expend their limited financial resources to purchase the improved cook stoves. Providing financial incentives for the amount of usage in time of the cleaner burning improved cook stoves will facilitate the adoption of the improved cook stoves. However, there is no existing reliable and accurate method for capturing and tracking the usage of cook stoves in rural areas.

Therefore, a system and method for conveniently, reliably, and accurately capturing and tracking the usage of cook stoves are highly advantageous.

### SUMMARY

An apparatus and method for encoding a stove usage time is described. The apparatus comprises a circuit, a temperature switch, an input device, and an output device. The circuit comprises a processor and an internal timer. The temperature switch is communicatively linked to the circuit. The input device is electrically connected to the circuit and is configured to transmit a status request to the processor in response to receiving a user input. The internal timer is configured to increment an accumulated time value of the internal timer by a usage time value. The usage time value is based on a duration the temperature switch detects temperatures higher than the minimum threshold. The processor is configured to access the incremented accumulated time value of the internal timer and store the incremented accumulated time value in a memory of the circuit. The processor is further configured to read the incremented accumulated time value from the memory of the circuit, encode the incremented accumulated time value into an encoded value, and in response to receiving the status request from the input device, cause the output device to produce the encoded value.

### BRIEF DESCRIPTION OF THE FIGURES

The present application can be best understood by reference to the following description taken in conjunction with the accompanying drawing figures, in which like parts may be referred to by like numerals.

FIG. 1 illustrates an exemplary stove timer in conjunction with a cook stove.

FIG. 2 illustrates an exemplary process for capturing and tracking the usage of cook stoves.

FIG. 3 illustrates an exemplary computing system.

### DETAILED DESCRIPTION

The following description sets forth numerous specific configurations, parameters, and the like. It should be recognized, however, that such description is not intended as a limitation on the scope of the present invention, but is instead provided as a description of exemplary embodiments.

Disclosed in the present application are systems and processes for encoding stove cook usage times. In one example, a stove timer is used to capture the duration of time that a stove has been used. This duration information is encoded into an alphanumeric value that is displayed for the stove user. The stove user may transmit this information to a central server. At the central server, the encoded duration information is received and decoded. Based on the received encoded duration information, the central server can determine the overall duration of usage for the stove and/or the duration of usage for the stove since the previous time the central server received encoded duration information for the stove.

FIG. 1 illustrates an exemplary stove timer in conjunction with a cook stove. The cook stove 102 is able to sustain a source of heat 112, such as a fire. The stove timer includes a temperature switch 104 and a display device 106. The temperature switch 104 is a temperature sensor, which can detect changes in temperature. The temperature switch 104 is attached to the stove 102 at a location near the source of heat 112. One of ordinary skill will appreciate that the elements described, such as the temperature switch 104 and the display device 106, may be, for example, built into the stove, permanently affixed to the stove, or detachable from the stove. The temperature switch 104 is located such that it can detect when the stove 102 is in use (e.g., producing heat) and when the stove 102 is not in use (e.g., not producing heat). The temperature switch 104 is configured such that it is in one of two states. The temperature switch 104 is in the first state when it senses a temperature above a minimum threshold temperature. This indicates that the stove 102 is in use. The temperature switch 104 is in the second state when it senses a temperature below a maximum threshold temperature. This indicates that the stove 102 is not in use. In one example, the minimum threshold temperature and the maximum threshold temperature are the same value. In another example, the minimum threshold temperature is several degrees (e.g., five degrees) higher than the maximum threshold temperature. This may prevent the temperature switch 104 from repeatedly fluctuating between the first state and the second state when the temperature switch 104 detects temperatures near the minimum threshold.

The minimum threshold temperature and the maximum threshold temperature are configured to be significantly higher than ambient temperatures. This helps to prevent the temperature switch 104 from incorrectly detecting that the stove 102 is in use when in fact the stove 102 is not in use. For example, the minimum threshold temperature may be 100 degrees Celsius and the maximum threshold temperature may be 65 degrees Celsius. Thus, sensor indicates the stove is in use when the temperature reaches above 100 degrees Celsius and then the sensor indicates the stove is not in use when the temperature drops below 65 degrees Celsius.

When the temperature switch 104 is in the first state, the temperature switch 104 transmits a first signal to the display device 106. The first signal is an “ON” signal indicating to the display device 106 that the stove is in use. When the temperature switch 104 is in the second state, the temperature switch 104 transmits a second signal to the display device 106. The second signal is an “OFF” signal indicating to the display device 106 that the stove is not in use. For example, the temperature switch 104 may achieve these two states by closing a wire circuit connected to the display device 106 when the temperature switch 104 is in the first state (ON) and opening the wire circuit connected to the display device 106 when the temperature switch 104 is in the second state (OFF). Thus, the first signal may be caused by a closed circuit in the temperature switch 104 and the second signal may be caused by an open circuit in the temperature switch 104.

The temperature switch 104 is communicatively connected to the display device 106. Preferably, the connection is by one or more wires, as this reduces complexity and cost. However, the connection between the temperature switch 104 and the display device 106 may also be through other means, such as wireless through the use of a personal area network or the like.

The display device 106 includes circuitry, an output device 108, and an input device 110. The circuitry of display device 106 is communicatively connected to the temperature switch 104. The circuitry is also electrically connected to the output device 108 and the input device 110. The circuitry is used to detect the state of the temperature switch 104. The circuitry may be, for example, an embedded computer chip or computer processor. The circuitry includes an internal timer that increments while the circuitry of the display device 106 detects that the temperature switch 104 is in the first state (ON). When the circuitry of the display device 106 detects that the temperature switch 104 is in the second state (OFF), the internal timer does not increment. Alternatively or in addition, the internal timer does not increment when the circuitry of the display device 106 detects that the temperature switch 104 is not in the first state. As the internal time increments, the value of the internal timer is repeatedly stored in memory. The memory may be in persistent memory, such as solid state memory, or in non-persistent memory, such as random access memory (RAM).

The output device 108 may be a visual display, a speaker, a line out, or the like. In the example of FIG. 1, the output device 108 is illustrated as a visual display, and in particular, as a liquid crystal display (LCD). Responsive to detecting that the temperature switch 104 is in the first state (ON), the circuitry of the display device 106 causes the output device to exhibit an indicator that indicates the internal timer is being incremented. In the example where an LCD being used as the output device, the LCD may: display a light, display a blinking colon (“:”), or display a message. This allows a user to know that the counter is incrementing. In the example where a speaker or a line out is used as the output device, a low volume audio tone or repeated beep may be used to indicate that the internal timer is incrementing. Responsive to detecting that the temperature switch 104 is in the second state (OFF), the circuitry of the display device 106 causes the output device to either not exhibit an indicator or to exhibit an indicator that indicates the internal timer is not being incremented. The value of the internal timer is stored in memory as an accumulated time value.

The internal timer may be configured to be reset by the user of the stove timer. The internal timer also has a maximum accumulated time value, after which the internal timer will roll over and begin incrementing from zero again. This will not affect determining the amount of time that has lapsed.

The input device 110 may be a single button, a keyboard input device, a radio frequency receiver, or the like. A user may use the input device 110 to send a status request signal to the circuitry of display device 106. In the example of FIG. 1, the input device 110 is illustrated as a single button. When the user activates the input device 110, the circuitry receives a status request signal. In this case, the input device 110 is activated by the user pressing the button. In response to the circuitry receiving the status request signal, the circuitry reads the accumulated time value stored in computer memory. The circuitry converts the accumulated time value into a numeric value by encoding the accumulated time value. The encoded numeric value is stored as an encoded value in memory. The circuitry then causes the output device 108 to produce the encoded value so that the user can know the encoded value. For example, the LCD device will display the numeric value on the visual display so that the user can view the value. In one example, the encoded value is displayed for a predetermined amount of seconds (e.g., 30 seconds) after the button input device 110 is pressed and the encoded value is displayed on the output device 108. In the example of FIG. 1, the encoded value is “45446” and is displayed on the output device 108.

The encoded value for each accumulated time value is different than the corresponding accumulated time value. Each encoded value can be converted into a single corresponding accumulated time value, and thus there is no ambiguity when an encoded value is decoded. An encoding technique is used that makes it difficult to convert the encoded value to the accumulated time value. For example, a decryption key may be required to convert the encoded value back into the accumulated time value. In one example, a cryptographic block cipher algorithm is used to transform the accumulated time value to the encoded value. In another example, a look up table is stored in the memory of the display device 106 for encoding the accumulated time value into the encoded value. The same look up table is available at a remote server for use to decode the encoded value into the accumulated time value.

Once the encoded value is displayed in output device 108, the user of the stove captures and transmits the encoded value to a remote server. Generally, the correlation between the accumulated time value and the encoded value is not obvious. This makes it difficult for a user to guess a valid encoded value to be transmitted to a remove server. The transmission of the encoded value may happen many different ways. In one example, a user types the numeric encoded value into a phone and transmits it to the remote server by using SMS. In another example, the user captures an image of the encoded value using the image sensor of a cellular phone and transmits the image to the remote server by using MMS, email, or another image transfer service. In yet another example, the user records an audio recording of the encoded value (which may consist of various tones of different frequencies) and transmits the audio file to the remote server.

In one exemplary embodiment, an internal timer of a stove timer has an initial accumulated time value of 305 minutes. The user of the stove presses a button on the stove timer which causes the stove timer to encode the accumulated time value of 305 minutes into an encoded value of 15662. The encoded value of 15662 is displayed on the LCD of the stove timer. The user reads this encoded value and sends a text message containing the encoded value of 15662 to a remote server. The remote server receives the encoded value of 15662 and converts the encoded value back into the accumulated time value of 305 minutes. Based on an identifier included in the text message, the phone number the text message originated from, or another identifier, the remote server stores the accumulated time value of 305 minutes in association with the user's profile on the remote server. The remote server may also store the date and/or time that the text message communication was received in association with the 305 minutes accumulated time value. Once the remote server receives the text message, the remote server transmits a confirmation to the server indicating a valid or invalid encoded value was received.

Subsequently, the user uses the stove for a duration of 25 minutes. During this 25 minutes of stove use, the temperature sensor of the stove timer detects that the temperature of the stove is above a minimum threshold and signals that the internal timer should increment. The internal timer continues to increment during the 25 minutes. After the user is finished cooking, the user turns the stove off. When the temperature detected by the temperature sensor drops below the maximum threshold, the temperature sensor signals that the internal timer should stop incrementing. The stove timer stores the accumulated time value of 305 minutes +25 minutes into memory as 330 minutes. The user then presses the button on the stove timer. In response, the stove timer encodes the 330 minutes accumulated time value into an encoded value of 91562. The encoded value of 91562 is displayed on the LCD of the stove timer. The user reads this encoded value and sends a text message containing the encoded value of 91562 to a remote server. The remote server receives the encoded value of 91562 and converts the encoded value back into the accumulated time value of 330 minutes. Based on the identifier, the remote server stores the accumulated time value of 330 minutes in association with the user's profile on the remote server. The date and/or time that the text message communication was received may also be stored in association with the 330 minutes accumulated time value. Using the 305 minutes accumulated time value previously stored and the 330 minutes accumulated time value currently stored, the remote server can calculate the amount of time that the stove has been used since the previous text message was received. In this case, the store has been used for 25 minutes. Once the remote server receives the text message, the remote server transmits a confirmation to the server indicating a valid or invalid encoded value was received.

By encoding the accumulated time value into an encoded value, incorrect or purposefully falsified reports of cooking time are minimized. A checksum digit is included in the encoded value to indicate whether the number was correctly entered and transmitted to the remote server. If an invalid encoded value is received, the remote server can prompt the user to resubmit a valid encoded value. The server may also transmit reminder messages to the user via SMS or other communications requesting that the user submit the encoded value displayed on the stove timer.

One technique for registering a stove counter or stove with an attached stove counter is to transmit an SMS message to the remote server for registration. The SMS may include a unique identifier of the stove or stove counter.

In one exemplary embodiment, an individual can use his or her mobile phone at the point of sale of a stove with a stove counter to register the stove. The user can send an SMS message to the remote server in the form of: “register <stove serial number>.” The remote server transmits a conformation SMS back to the user. The confirmation may say, for example: “Thank you for registering with Surya Stove. To submit cooking duration, please send an SMS with the number on the display.”

One way to minimize fraud is to limit the number of phones (or phone numbers) that may be associated with one stove. For example, the remote server may only allow a one-to-one relationship between phones (or phone numbers) and stove serial numbers.

Payment for using the stove encourages individuals to purchase the stove and use the cleaner burning stove in place of older conventional cook stoves. When the system determines that a user has used a stove for a duration of time, the user is credited for the time the stove was used. The credit may be issued in the form of cash, check, credit towards an existing bill (such as a phone bill), or the like.

In one exemplary embodiment, two temperature sensors (or temperature switches) may be used. Accordingly, the system is configured to receive temperature readings and/or ON/OFF signals from both temperature sensors. A first temperature sensor is used in association with the minimum temperature value. When the system determines that the first temperature sensor detects temperatures above the minimum temperature value, the timer begins to run. The second temperature sensor is used in association with the maximum temperature value. When the system determines that the second temperature sensor detects temperatures below the maximum temperature value, the timer stops running. The maximum temperature value may be less than the minimum temperature value. One of ordinary skill in the art will appreciate that other aspects described may be incorporated into this embodiment and that aspects of this embodiment may be incorporated into other described configurations.

In another exemplary embodiment, two temperature sensors (or temperature switches) may be used. Accordingly, the system is configured to receive temperature readings and/or ON/OFF signals from both temperature sensors. The first temperature sensor may be a thermistor that sends an analog or digital signal to the device circuitry indicative of the detected temperature. The system accesses this temperature reading and determines whether to power on additional portions of the system (or power off) by comparing the temperature reading to a first set of stored minimum and/or maximum temperature values. The second temperature sensor is used to determine when to start and stop the timer that tracks the duration of stove use. When the temperature reading is above a second minimum temperature value it will start counting. When the temperature value goes below a second maximum temperature value it will stop counting. The second maximum temperature value may be less than the second minimum temperature value. One of ordinary skill in the art will appreciate that other aspects described may be incorporated into this embodiment and that aspects of this embodiment may be incorporated into other described configurations.

FIG. 2 illustrates an exemplary process for capturing and tracking the usage of cook stoves. In general, the blocks of FIG. 2 may be performed in various orders, and in some instances may be performed partially or fully in parallel. Additionally, not all blocks must be performed.

At block 202, the stove timer system boots up. At block 204, the system is placed into a high-power mode. When in the high-power mode, all or more aspects of the system are functional, but at the cost of higher power and/or battery usage. At block 206, the system accesses an accumulated time value that was previously stored in memory. At block 208, the system checks the state of the temperature switch. If the temperature switch is OFF, indicating that the temperature switch is not detecting a temperature above a threshold, the system moves to block 210. If the temperature switch is ON, indicating that the temperature switch is detecting a temperature above the threshold, the system moves to block 216.

At block 210, the system checks the state of the input button. If the input button status is ON, it is indicative that the button has been depressed, and the system progresses to block 212. At block 212, the system encodes the accumulated time value accessed at block 206 into an encoded value. The encoded value is displayed on an LCD at block 214. The system then returns to block 208 to check the state of the temperature switch. If the input button status is OFF, it is indicative that the button has not been depressed, and the system progresses to block 226. At block 226, the system enters a low-power mode. The low-power mode shuts off part of the electronics of the system in order to conserve power or battery. This comes at the cost of reduced functionality. The system may be configured to periodically come out of low-power mode to check for inputs or temperature switch states.

At block 216, the system starts an internal timer. The timer may progress starting from the accessed accumulated time value or may progress from 0. At block 218, an indicator informs the user that the internal timer is running. The indicator may be, for example a light on an LED or LCD. At block 220, the system checks the state of the temperature switch. If the temperature switch is ON, the timer continues to run and the system returns to block 218. If the temperature switch is OFF, the system stops the internal timer at block 222. If the timer had progressed from a value of 0, the timer value is added to the accumulated time value of block 206. At block 224, the updated accumulated time value is stored in memory. At block 226, the system enters a low-power mode. The system may be configured to periodically come out of low power mode to check for inputs or temperature switch states.

FIG. 3 depicts an exemplary computing system 300 configured to perform any one of the above-described processes. In this context, computing system 300 may include, for example, a processor, memory, storage, and input/output devices (e.g., camera sensor, monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

FIG. 3 depicts computing system 300 with a number of components that may be used to perform the above-described processes. The main system 302 includes a motherboard 304 having an input/output (“I/O”) section 306, one or more central processing units (“CPU”) 308, and a memory section 310, which may have a flash memory card 312 related to it. The I/O section 306 is connected to a display 324, an image sensor 326, a keyboard 314, a disk storage unit 316, and a media drive unit 318. The media drive unit 318 can read/write a computer-readable medium 320, which can contain programs 322 and/or data.

In one example, the computing system 300 may include one or more processors and instructions stored in a non-transitory computer-readable storage medium, such as a memory or storage device, that when executed by the one or more processors, perform the processes for encoding a stove usage time as discussed above. In the context of the embodiments described herein, a “non-transitory computer readable-storage medium” can be any medium that can contain or store the program for use by or in connection with the instruction execution system, apparatus, or device. The non-transitory computer-readable storage medium can include, but is not limited to, an electronic, magnetic, optical, electromagnetic, infrared, or semiconductor system, apparatus or device, a portable computer diskette, a random access memory (RAM), a read-only memory (ROM), an erasable programmable read-only memory (EPROM), a portable optical disc such a CD, CD-R, CD-RW, DVD, DVD-R, or DVD-RW, or flash memory such as compact flash cards, secured digital cards, USB memory devices, memory sticks, and the like.

At least some values based on the results of the above-described processes can be saved for subsequent use, such as accumulated time values or encoded values. Additionally, a non-transitory computer-readable storage medium can be used to store (e.g., tangibly embody) one or more computer programs for performing any one of the above-described processes by means of a computer. The computer program may be written, for example, in a general-purpose programming language (e.g., Pascal, C, C++) or some specialized application-specific language.

Although certain exemplary embodiments have been described in detail above, those skilled in the art will readily appreciate that many modifications are possible to the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. An apparatus for encoding a stove usage time, the apparatus comprising:
a circuit comprising a processor and an internal timer;
a temperature switch communicatively linked to the circuit;
an input device, the input device electrically connected to the circuit and the input device configured to transmit a status request to the processor in response to receiving a user input;
an output device;
wherein the internal timer is configured to increment an accumulated time value of the internal timer by a usage time value, the usage time value based on a duration the temperature switch detects temperatures higher than the minimum threshold; and
wherein the processor is configured to:
access the incremented accumulated time value of the internal timer and store the incremented accumulated time value in a memory of the circuit;
read the incremented accumulated time value from the memory of the circuit;
encode the incremented accumulated time value into an encoded value; and,
in response to receiving the status request from the input device, cause the output device to produce the encoded value.

2. The apparatus of claim 1, wherein, in response to the temperature switch detecting temperatures higher than the minimum threshold temperature, the output device is configured to exhibit an indicator, the indictor indicating that the internal timer is being incremented.

3. The apparatus of claim 1, wherein:
the input device is a button;
the output device is a liquid crystal display (LCD);
the temperature switch is a temperature sensor; and
the temperature sensor is connected to the circuit by one or more electrical connections.

4. The apparatus of claim 3, wherein:
causing the output device to produce the encoded value comprises causing the LCD to visually display the encoded value in numerical format.

5. The apparatus of claim 1, wherein the time value is an accumulated time indicating a duration of time for which a stove to which the apparatus is attached has been turned on.

6. The apparatus of claim 1, wherein:
the temperature switch is configured to transmit a first signal to the circuit in response to the temperature switch detecting temperatures higher than a minimum threshold temperature.

7. The apparatus of claim 6, wherein:
the temperature switch is configured to transmit a second signal to the circuit in response to the temperature switch detecting temperatures lower than a maximum threshold temperature.

8. The apparatus of claim 1, wherein, in response to receiving the status request from the input device, the processor is further configured to store the encoded value in the memory of the circuit.

9. A method for communicating stove usage times, the method comprising:
at a stove timer:
accessing a memory location storing an accumulated stove usage time value;
detecting a first temperature value;
determining that the first temperature value exceeds a minimum temperature threshold value;
starting an internal timer in response to determining that the temperature value exceeds the minimum threshold value, the internal timer incrementing the accumulated stove usage time value stored at the memory location;
displaying an indicator, the indictor indicating that the internal timer is running;
detecting a second temperature value, wherein the second temperature value is at a lower temperature than the first temperature value;
determining that a maximum temperature threshold value exceeds the second temperature value;
stopping the internal timer in response to determining that the maximum temperature threshold value exceeds the second temperature value;
accessing the memory location storing the incremented accumulated stove usage time value;
encoding the incremented accumulated stove usage time value into an encoded value; and
displaying the encoded value for transmission to a remote server.

10. The method of claim 9, further comprising:
at a remote server:
receiving the encoded value;
decoding the encoded value into a decoded value;
storing the decoded value in a memory; and
determining a compensation value based on the decoded value.

11. The method of claim 10, wherein the compensation value is a dollar amount applied to the telephone bill of a user associated with the stove timer.
